(19) United States
(12) Patent Application Publication
(10) Pub. No.: US 2015/0129820 A1
(43) Pub. Date: May 14, 2015

(54) Dual Level, Trailerable Mechanic's Ramp

(71) Applicant: Daniel James Svihla, Portland, OR (US)

(72) Inventor: Daniel James Svihla, Portland, OR (US)

(21) Appl. No.: 14/079,413

(22) Filed: Nov. 13, 2013

(51) Int. Cl. B66F 5/04; B66F 17/00; B66F 7/28; B66F 11/04; B66F 7/22; B66F 7/24

(52) U.S. Cl. CPC B66F 5/04; B66F 7/22; B66F 7/243; B66F 7/28; B66F 11/04; B66F 17/006; B66F 2700/05; B66F 2700/123
USPC 254/3 B

(57) ABSTRACT

An extremely compact, trailerable vehicle ramp that utilizes a unique, economical manner of locking the lift and raising the vehicle that is adapted to provide both safety and convenience for the user. The lift can be locked into a horizontal position with the base frame raised so that it can be towed to the desired location, such as a racetrack. Once there, the frame can quickly be lowered hydraulically until it rests on the ground simultaneously effecting the locking of the wheels. With the retraction of a couple of pins the two ramps may be tilted down at the rear and a vehicle driven on it forward until the vehicle's front wheels reach the stops in the ramp tracks. The rear of the ramp tracks may now be raised hydraulically until the ramp tracks are horizontal and the vehicle has been raised off the ground. The rear of the ramp tracks may be locked up. In this position the lift ramp is perfectly positioned beneath the center of the vehicle's frame. The lift ramp may be raised hydraulically as well if additional work space is required beneath the vehicle, or the vehicle tires are to be removed.

Americans are obsessed with their vehicles. The die hard car enthusiasts not only display their vehicles but display their prowess in modifying and restoring their vehicles. Key to much of this is the ability to be able to get underneath the vehicle to work on the undercarriage, suspension, transmission etc. Unfortunately, raising a vehicle off the ground so that one can comfortably work on it, heretofore has been an expensive and location specific task. Most vehicle lifts are securely anchored to the ground as in a garage and are very expensive. The present invention allows portability and flexibility in the design of a mechanic's ramp.

### BACKGROUND OF THE INVENTION

The present invention relates to a extremely compact, trailerable mechanic's ramp that utilizes a unique, economical manner of locking the lift and raising the vehicle that is adapted to provide both safety and convenience for the user.

The biggest problem with existing vehicle ramps is their availability in remote locations. Those ramps that are portable take an inordinate amount of time to properly and safely erect. The second problem is that most portable ramps are height and or weight limited. All said and done, most prior art portable vehicle ramps offer no more working advantages than a floor creeper.

The present portable mechanic's ramp fulfills a long felt need in the field of vehicle maintenance as it requires no set up, can easily be transported anywhere a vehicle can go, is extremely strong and can vertically raise a vehicle to a second level that allows the stoutest of mechanics to comfortably work beneath the vehicle.

### SUMMARY OF THE INVENTION

The general purpose of the present invention, which will be described subsequently in greater detail, is to provide a trailerable, dual level vehicle ramp that is able to be towed virtually anywhere and accommodate at least two levels of vertical lift for a vehicle. The locking of the ramp and the ramp's great stability is accomplished by lowering of the ramp's frame concurrently with the locking of the ramp's wheels such that the ramp forms a torsion box design for stability when raising a vehicle or when a vehicle is driven onto the vehicle ramps. The large rectangular footprint the frame places on the ground offers superior stability and rigidity. The placement of the lifts and their width eliminates the requirement for any specific positioning or adjustments before a vehicle can be raised to the secondary position. Speed, strength and simplicity are the key features of this invention.

It has many of the advantages mentioned heretofore and many novel features that result in a new portable mechanic's ramp which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front side perspective view of the dual level, trailerable mechanic's ramp with the lift in the locked and fully raised configuration and the ramps raised;

FIG. 2 is a front side perspective view of the dual level, trailerable mechanic's ramp in the trailering configuration with the ramps lowered;

FIG. 3 is a top view of the dual level, trailerable mechanic's ramp with the lift in the raised configuration;

FIG. 4 is a side view of the dual level, trailerable mechanic's ramp with the lift locked and raised and the ramps locked and raised;

FIG. 5 is a front view of the dual level, trailerable mechanic's ramp with the lift locked and raised and the ramps locked and raised;

FIG. 6 is a top view of the dual level, trailerable mechanic's ramp with the lift in the lowered configuration;

FIG. 7 is a left side view of the dual level, trailerable mechanic's ramp in the trailering configuration with the ramps lowered;

FIG. 8 is an end view of the dual level, trailerable in the trailering configuration with the ramps lowered;

FIG. 9 is right side view of the dual level, trailerable in the trailering configuration with the ramps lowered;

FIG. 10 is a side perspective, cross sectional view of the frame lowering assembly with the frame raised;

FIG. 11 is a side perspective view of the frame lowering assembly with the frame raised;

FIG. 12 is a side perspective view of the frame lowering assembly with the frame lowered; and

FIG. 13 is a schematic representation of the hydraulic system.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

The operation of the mechanic's ramp 2 is designed with simplicity, speed, comfort and safety in mind. It is designed to allow a mechanic or car enthusiast to bring their own mechanic's ramp to a remote location so as to enable working access to the underside of the vehicle and to allow the vehicle to be raised by its chassis or frame such that the wheels are suspended mid air. The mechanic's ramp is not designed to transport a vehicle.

There are four configurations of the mechanic's ramp. Trailering, vehicle loading, vehicle tilt and vehicle lift. These four configurations are enabled by various position combinations of the three pair of actuation cylinders. Although the preferred embodiment utilizes hydraulic cylinders, it is well known in the field that substitution of a system with pneumatic or electric actuation cylinders could constitute a functional equivalent.

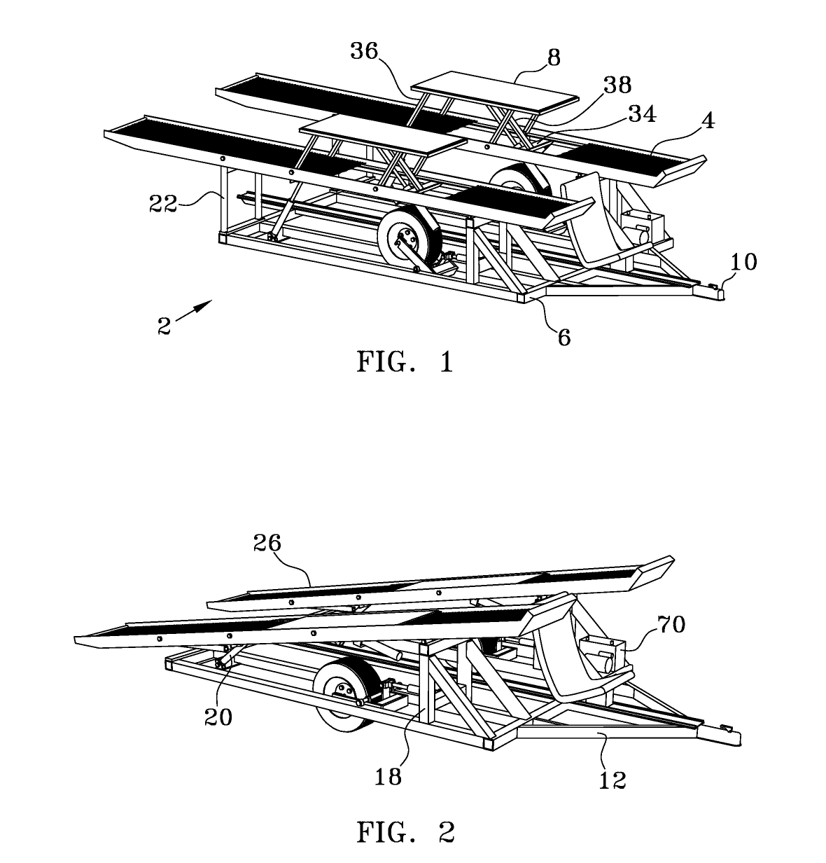

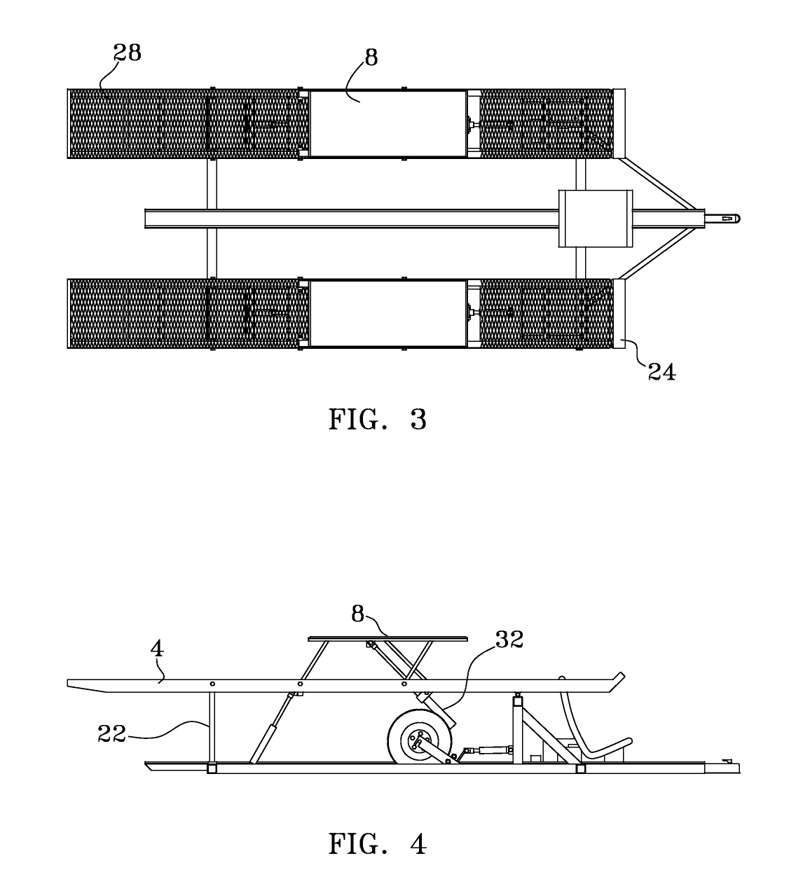

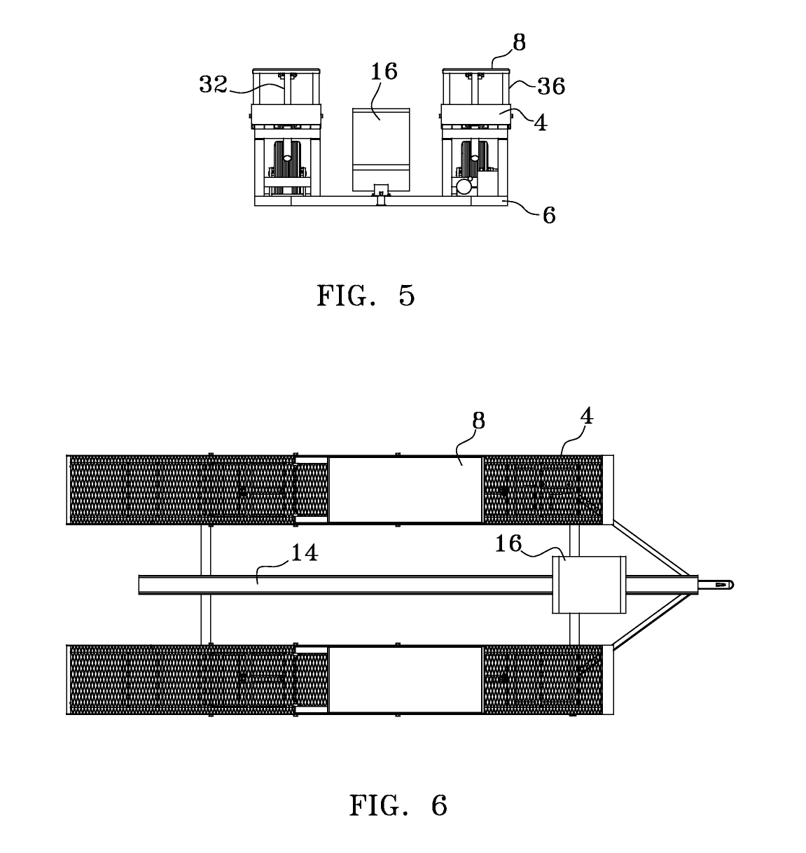

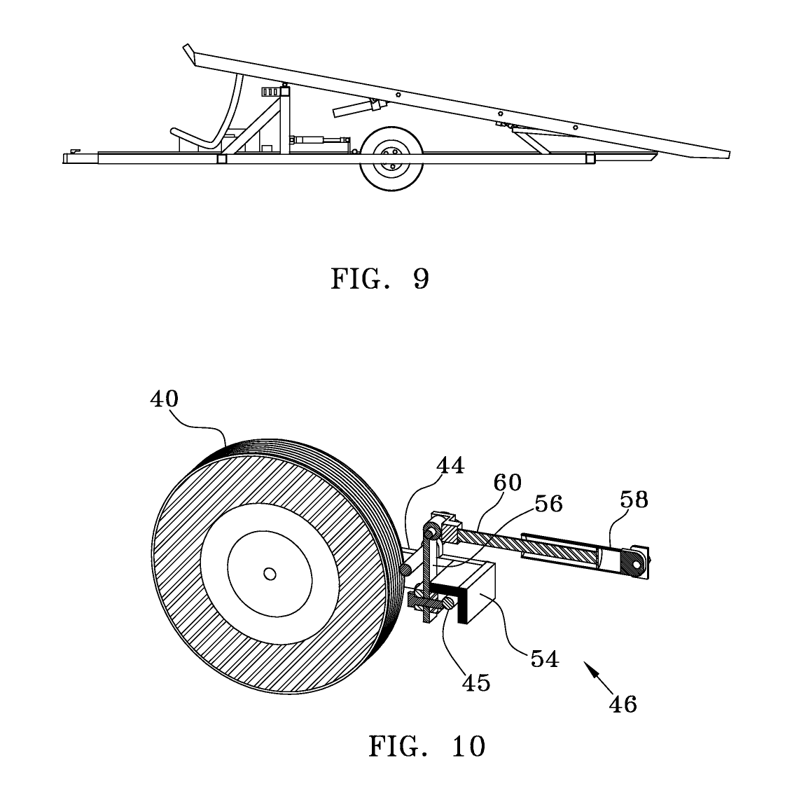

Looking at FIGS. 1, 3, 4, 5 and 12 the mechanic's ramp 2 can best be seen in its full working configuration with the vehicle ramps 4 fully raised, the base frame 6 fully lowered and the lifts 8 fully raised. This may be contrasted with FIGS. 2, 6, 7, 8, 9, 10 and 11 illustrating the mechanic's ramp 2 in the trailerable configuration with the base frame 6 raised and locked, the lifts 8 fully lowered and the vehicle ramps 4 lowered at the rear.

The mechanic's ramp 2 has a generally rectangular base frame 6 made of mechanically connected or welded steel tubing, preferably square or rectangular. It is planar on its bottom side to ensure even weight distribution and full contact when lowered to the ground. On the front side, the base frame 6 extends into a triangular hitch receiver support 12 which houses a ball hitch receiver 10. This ball hitch receiver is adapted for coupling to a ball hitch of a tow vehicle for transporting. Although in the preferred embodiment a ball connection is utilized, it is known that there is a plethora of different systems to connect the mechanic's ramp 2 to a tow vehicle including but not limited to a goose neck coupler, a pintel hook coupler, or a fifth wheel coupler. Running parallel to the longitudinal axis of the mechanic's ramp 2 and approximately centered within the base frame 6 is a linear chair track 14. In this track 14 a mechanic's chair 16 is slidingly mounted for linear travel and twisting movement along the length of the base frame 6. (FIG. 6) This allows the mechanic to work in comfort underneath a raised vehicle.

Onto the front section of the base frame 6 are affixed two stanchion assemblies 18 that extend normally in the vertical plane. The stanchion assemblies 18 are of a stout design and incorporate multi point bracing to the base frame 4. The vehicle ramps 4 are pivotally connected on their top end to the these stanchion assemblies 18. This pivotal connection allows for the vehicle ramps 4 to be lowered from the rear so as to allow a vehicle to be driven up onto the vehicle ramp 4 when the base frame 4 is lowered to contact the ground. It also allows for the vehicle ramp 4 to be raised from the rear once a vehicle is driven onto them such that the vehicle and the vehicle ramps 4 will be in a horizontal orientation.

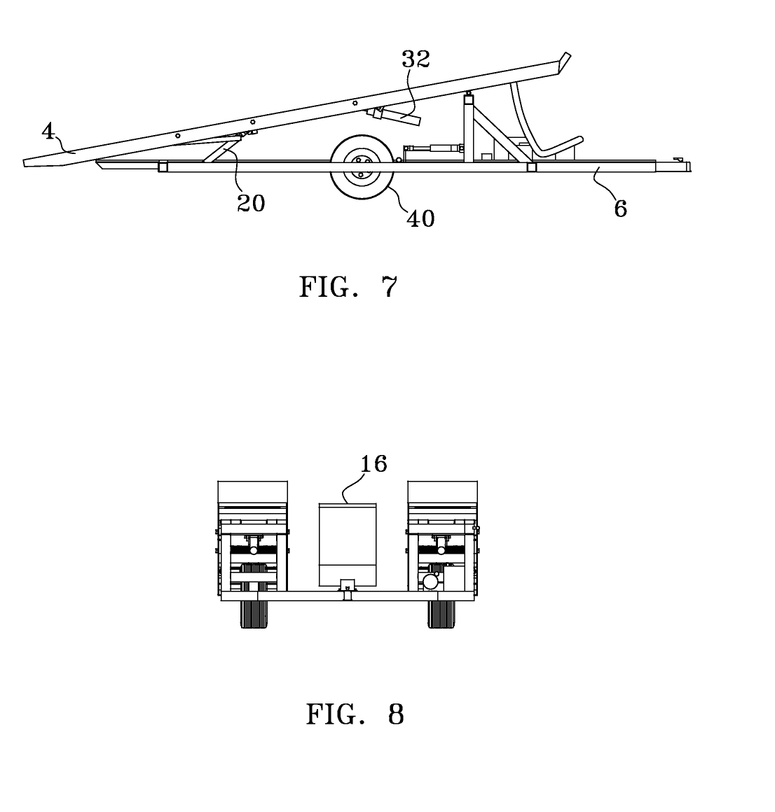

At the back of the base frame 4 are a pair of ramp lift cylinders 20 that are pivotally connected at their bottom end to the base frame 4 and pivotally connected at their top end to the vehicle ramp 4. The ramp lift cylinders 20 extend at an acute angle from the base frame 6 and when extended raise the rear of the vehicle ramps 4 upward until the vehicle ramps 4 are horizontally oriented. (FIG. 7) When raised up to the horizontal position a pair of rear safety arms 22 pivot down from their nested position under the vehicle ramps 4 and rest on the base frame 6 where they can be safely constrained mechanically. (FIG. 4) Such a mechanical constrainment may be by pin, bolt, device, insertion into a detent or the like as is well known in the art. This serves to ensure that the vehicle ramps 4 do not lower upon a failure of the ramp lift cylinders 20.

Each vehicle ramp 4 is of a planar, linear configuration having a front nose stop 24 to signal the driver that the vehicle has be brought to the foremost limit of the vehicle ramps 4. There is also raised peripheral edges 26 along each side of the length of the vehicle ramps 4 to help guide the wheels into a centered position on the vehicle ramps 4. The vehicle ramps 4 each have an open steel grating 28 on their upper planar faces. Between the raised peripheral edges 26 along each side of the length of the vehicle ramps 4 is nested a pair of lifts 8. Each lift 8 is a planar plate that when raised horizontally, contacts a large percentage of the surface of the underside of the vehicle's frame or unibody so as to securely raise the vehicle to a second height if necessary. Lift hydraulic cylinders 32 have their body pivotally mounted to support members 34 affixed to the vehicle ramps 4 and the top end of their extendible ram pivotally affixed to a strengthening brace on the underside of the vehicle ramps 4. (not illustrated but this type of connection is well known in the mechanical art) Each of the lifts 8 have a set of four legs 36 that are pivotably connected between the lift 8 and the vehicle ramp 4. When the lift hydraulic cylinders 32 are extended the top end of their rams force the lift 8 upward and backward. However, at full extension of the ram, the four legs 36 still remain at an acute angle with respect to the linear axis of the vehicle ramps 4. This prevents the lift 8 from being raised beyond normal (90 degrees) with respect to the longitudinal axis of the ramp 4. When fully raised, there is a safety support 38 that pivots down from the underside of the lift 8 so as to reside on the support member 34, thus preventing the lift 8 from lowering in the event of a failure of the lift hydraulic cylinders 32. This safety support 38 may be locked into mechanical constrainment by pin, bolt, clevice, insertion into a detent similar to the safety arms 22 above, however in the preferred embodiment the support member 34 is fabricated from angle steel so as to contact two sides of the safety support 38.

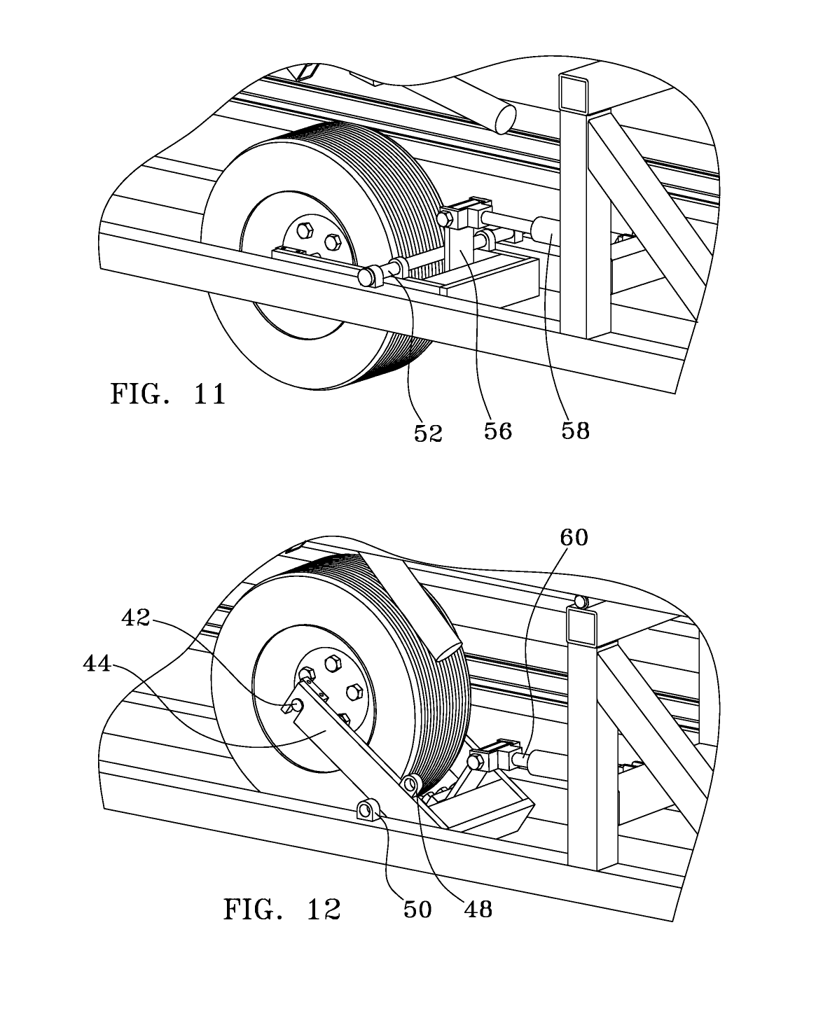

Looking at FIGS. 10, 11 and 12, it can be seen that the base frame 6, while towable, is not directly connected to the wheels 40, rather it connects through the frame lowering assembly 46. The wheels 40 rotate about axle 42 which resides between the two parallel side arms 44 of the frame lowering assembly 46. The frame lowering assembly 46 has a frame axle 45 that passes through the assembly 46 and extends beyond either of the two side arms 44 and is affixed to the frame 6. This axle allows the frame 6 to move in relation to the frame lowering assembly 46 as the frame drops to the ground or is raised. On the side arms 44 are a set of first locking pin loops 48 which align with a set of second locking pin loops 50 on the base frame 6 only when the base frame 6 is raised to the trailerable or towable configuration. At this position of horizontal locking pin loop alignment, a locking pin 52 can be inserted through all sets of locking pin loops 48 and 50 as illustrated in FIG. 11. This then connects the axle 42 to the base frame 6, with the base frame 6 in the raised position, ready to be moved.

Connected between the two parallel side arms 44 of the frame lowering assembly 46 is a brace 54 that mechanically connects to the bottom end of the base frame lowering linkage 56. The top end of the base frame lowering linkage 56 is pivotally affixed to the top end of a ram 60 that extends from the base frame lowering hydraulic cylinder 58 that is connected to the stanchion 18. When the locking pin 52 is withdrawn from all sets of locking pin loops 48 and 50, and the base frame lowering hydraulic cylinder 58 is actuated to retract its ram 60, the base frame lowering linkage 56 is pivotally pulled toward the stanchion 18 shortening the distance between the wheel 40 and the stanchion 18, forcing the base frame 6 and the base frame lowering assembly brace 54 to descend to the ground.

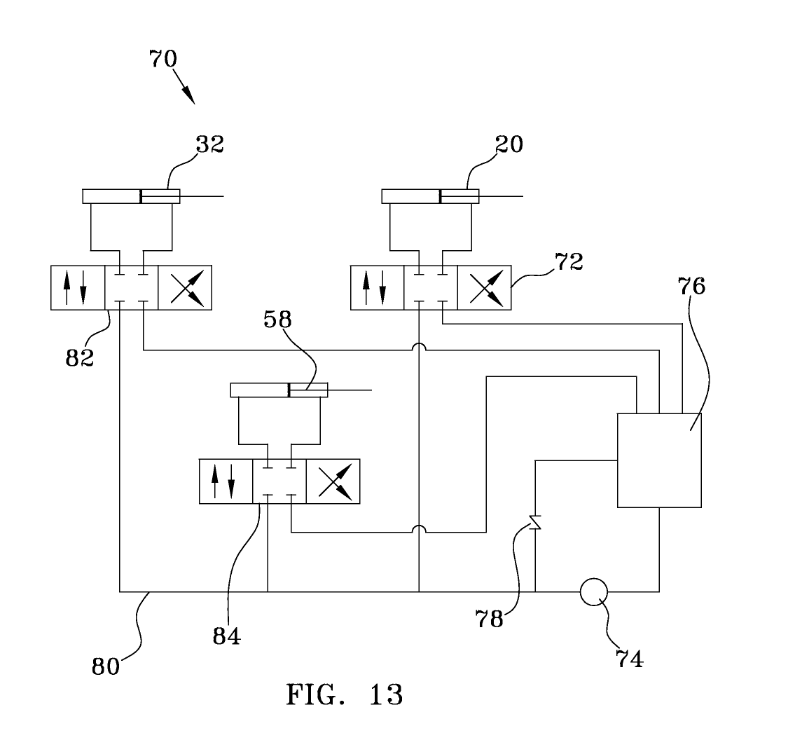

On the mechanic's ramp 2 is a control system 70 that allows for the hydraulic raising and lowering of the lift 8, the rear end of the vehicle ramps 4 and the base frame 6. This system includes the hydraulic valve controls, the hydraulic valves 72, hydraulic pump 74, hydraulic fluid reservoir tank 76, check valve 78, status lights, associated hydraulic tubing 80, electrical wiring, electrical converter and electrical power and supply (battery). FIG. 13 is a schematic representation of this system wherein it can be seen that the hydraulic pump 74 draws hydraulic fluid from the reservoir tank 76 and provides a pressurized volume of hydraulic fluid to the inlet side of the base frame lowering hydraulic cylinder's directional valve 82, the lift hydraulic cylinder's directional valve 84 and the ramp lift hydraulic cylinder's directional valve. Upon electrical actuation of any one of these hydraulic cylinder directional valves from their controls, the pressurized fluid is allowed to enter the top or bottom end of the hydraulic cylinders so as to extend or retract the hydraulic cylinder's ram. This is determined by the alignment of the hydraulic fluid ports. When the hydraulic valves are in their closed (central) position, the pressure in the hydraulic lines 80 builds up high enough to open the check valve 78 allowing the hydraulic fluid to return to the reservoir tank 76 and allowing the hydraulic pump to continue to run and maintain available fluid volume and pressure at each of the hydraulic valves. This system in its preferred embodiment utilizes DC power from its own battery but can be charged or augmented from the tow vehicles electrical system. AC electric power can be utilized passing through the on board converter or rectifier. While the preferred embodiment uses electrically operated hydraulic valves it is well known in the art that hydraulic operated hydraulic valves may also be utilized.

The four operational modes, trailering, vehicle loading, vehicle tilt and vehicle lift are enabled and used as follows. In the trailering configuration as seen in FIG. 2 the mechanic's ramp 2 is ready for coupling to a ball hitch of a tow vehicle by its ball hitch receiver 10. The base frame 6 has been lowered at its rear by retraction of the ram in the ramp lift hydraulic cylinder 20 and the ram has been extended in the base frame hydraulic cylinder 58 so as to raise the base frame lowering linkage 56 such that the locking pin 52 has been inserted through all sets of locking pin loops 48 and 50. Once the connection to the tow vehicle has been made, the mechanic's lift 2 may be towed.

In the vehicle loading configuration, FIG. 12 the mechanic's lift 2 is uncoupled from the tow vehicle and the locking pin 52 has been removed from all sets of locking pin loops 48 and 50. The base frame lowering hydraulic cylinder 58 has retracted its ram so as to lower the base frame lowering linkage 56 such that such that the entire base frame 6 resides on the ground. The vehicle can now be driven up the vehicle ramps 4 until the front wheel contacts the front nose stop 24.

In the vehicle tilt configuration, with the vehicle on the ramps 4, the ramp lift cylinder 20 extends its ram to raise the back end of the ramps 4 while the front end connection of the ramps 4 pivots about its attachment point to the stanchions 18. Once the ramps 4 are horizontal the pair of rear safety arms 22 are pivoted downward onto the base frame 6 to lock the ramps 4 in place.

In the vehicle lift configuration (FIG. 1) the ram of the lift hydraulic cylinder 32 is extended so as to move the lifts 8 pivot back and upward on their legs 34. At the full stroke of the ram the safety supports 38 are pivoted down to a locked position on the support member 34. Returning any of these configurations to the previous one requires the reverse operation of the above steps.

The invention is capable of other embodiments and of being practiced and carried out in various ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A trailerable mechanic's ramp comprising:
a trailerable, hydraulically lowerable frame;
at least one pair of wheels;
at least one frame lowering assembly;
at least one wheel axle, rotatable supporting one of each of said wheels thereon said frame lowering assembly;
at least one frame axle, pivotally connected between one of each said frame lowering assemblies and said frame; and
a pair of tiltable vehicle ramps pivotally affixed to said frame.

2. The trailerable mechanic's ramp of claim 1 further comprising:
a pair of vehicle lifts each pivotally affixed to one of said vehicle ramps; and
a hydraulic actuating system adapted to raise and lower said frame, to raise and lower a back end of said vehicle ramps, and to raise and lower said vehicle lifts.

3. The trailerable mechanic's ramp of claim 2 wherein said hydraulic actuating system further comprises:
a pair of vehicle ramp tilt cylinders operationally connected between said lowerable frame and said vehicle ramp;
a pair of vehicle lift cylinders operationally connected between said vehicle lifts and said frame; and
a pair of frame lowering cylinders operably connected between said frame and said frame lowering assemblies.

4. The trailerable mechanic's ramp of claim 3 further comprising a sliding chair assembly adapted for the movement of a chair along a track affixed to said frame, said track residing parallel to a longitudinal axis of said mechanic's ramp.

5. The trailerable mechanic's ramp of claim 3 having at least one locking pin insertable in a series of horizontally alignable locking pin loops located on said frame lowering assemblies and on said frame.

6. The trailerable mechanic's ramp of claim 5 having at least one pair of safety legs pivotally affixed at a distal end to said vehicle ramp to enable contact of said safety legs at a proximate end with said base frame to enable support of said vehicle ramp.

7. The trailerable mechanic's ramp of claim 6 having at least one safety support pivotally extending between said lift and a support member affixed to said base frame.

8. A trailerable mechanic's ramp comprising:
a trailerable, hydraulically lowerable frame having at least one front stanchion;
at least one pair of wheels;
a pair of frame lowering assemblies;
a pair of wheel axles, each axle rotatable supporting one of said wheels, wherein said wheel axles are mounted on said frame lowering assembly;
a pair of frame axles, each said frame axle housed in said frame lowering assemblies and each said frame axle having two ends that extend therefrom said frame lowering assemblies and are connected to said frame;
a locking mechanism to facilitate the rigid constrainment of said frame to said frame lowering assembly thereby preventing the lowering of said frame;
a pair of tiltable vehicle ramps pivotally affixed at a first end to said front stanchion of said frame; and
a pair of raiseable vehicle lifts each pivotally affixed to one of said vehicle ramps; and
a hydraulic actuating system adapted to raise and lower said frame, by retraction and extension of a pair of base frame lowering hydraulic cylinders that are affixed at a first end to said frame and affixed at a second end to said frame lowering assemblies.

9. The trailerable mechanic's ramp of claim 8 wherein said hydraulic actuating system is adapted to tilt said vehicle ramps by refraction and extension of a pair of vehicle ramp hydraulic cylinders that are affixed at a first end to said frame and affixed at a second end to said vehicle ramp.

10. The trailerable mechanic's ramp of claim 8 wherein said hydraulic actuating system is adapted to raise said lifts by retraction and extension of a pair of lift hydraulic cylinders that are affixed at a first end to said lift and affixed at a second end to said base frame.

11. The trailerable mechanic's ramp of claim 9 wherein said hydraulic actuating system is adapted to raise said lifts by retraction and extension of a pair of lift hydraulic cylinders that are affixed at a first end to said lift and affixed at a second end to said base frame.

12. The trailerable mechanic's ramp of claim 8 further comprising:
a slidingly moveable mechanic's chair; and
a linear track affixed approximately centrally to said frame and oriented approximately parallel to a linear axis of said frame;
wherein said chair is pivotally affixed to said linear track for sliding movement along a length of said track.
